(19) United States
(12) Patent Application Publication
(10) Pub. No.: US 2018/0308349 A1
(43) Pub. Date: Oct. 25, 2018

(54) Bidirectional Wireless Infrared Relay Control Device with Pairing Function and Control Method Thereof

(71) Applicant: Yi-Kung Hsu, Tainan (TW)

(72) Inventor: Yi-Kung Hsu, Tainan (TW)

(21) Appl. No.: 15/493,193

(22) Filed: Apr. 21, 2017

(51) Int. Cl. G08C 23/04; H04B 10/114

(52) U.S. Cl. CPC G08C 23/04; H04B 10/1143

(57) ABSTRACT

A bidirectional wireless infrared relay control device includes an infrared reception module connected to a microprocessor module. A remote controller of an external electric appliance is sent by the infrared reception module to the microprocessor module for decoding. A selection module is connected to the microprocessor module and provides the microprocessor module with a set code signal of transmission or reception. A first wireless processing module is connected to the microprocessor module. The microprocessor module cooperates a code from the selection module to generate a radio frequency signal to be transmitted by the first wireless processing module. A second wireless processing module is connected to the microprocessor module. The second wireless processing module is set by the microprocessor module and the selection module to receive the radio frequency signal. An infrared transmission module is connected to the microprocessor module. A control method of using the control device is also disclosed.

### BACKGROUND OF THE INVENTION

The present invention relates to a bidirectional wireless infrared relay control device with a pairing function and a control method thereof and, more particularly, to an easy-to-install control device and a control method for increasing the operational convenience of electric appliances through wireless infrared relay transmission while permitting setting of the object of transmission or reception.

Electric appliances are one of daily necessities of modern lives. To improve the use convenience of electronic appliances, a connection integration device is used for integrating various electric appliances. For example, a television can be connected through wires to a set-top box, a digital versatile disc (DVD) player, and an amplifier and can play films with a better audio/video effect. Each electric appliance is generally equipped with an infrared receiver and a remote controller capable of emitting infrared rays for easy operation through remote control.

However, the infrared transmitter on the remote controller must be aligned with the infrared receiver on the television for operation. Namely, the control requires oriental alignment. Furthermore, infrared rays can only be received in a short distance, and the operation is inconvenient.

Furthermore, a family generally has two or more televisions located in different rooms or different floors of the house. These televisions can be connected by wires to a common DVD player in a room. In a case that a user is watching a television also placed in the room, operational control of the DVD player is convenient. However, if the user is watching a television placed in another room, the user has to go to the room to operate the DVD player and the amplifier before watching the television. The operation is, thus, inconvenient. Furthermore, if it is desired to pause the film, the user has to go to the room in which the DVD player is placed, causing more inconvenience in operation.

### BRIEF SUMMARY OF THE INVENTION

An objective of the present invention is to provide an easy-to-install control device and a control method for increasing the operational convenience of electric appliances through wireless infrared relay transmission while permitting setting of the object of transmission or reception.

A bidirectional wireless infrared relay control device with a pairing function according to the present invention includes a microprocessor module and an infrared reception module electrically connected to the microprocessor module. The infrared reception module is configured to receive an infrared control signal from a remote controller of an external electric appliance and is configured to send the infrared control signal to the microprocessor module for decoding. A selection module is electrically connected to the microprocessor module and is configured to provide the microprocessor module with a set code signal of transmission or reception. A first wireless processing module is electrically connected to the microprocessor module and includes a first antenna. The microprocessor module cooperates a code from the selection module to generate a radio frequency signal with a corresponding frequency. The first wireless processing module is configured to send out the radio frequency signal via the first antenna. A second wireless processing module is electrically connected to the microprocessor module and includes a second antenna. The second wireless processing module is set by the microprocessor module and the selection module to receive the radio frequency signal. An infrared transmission module is electrically connected to the microprocessor module. A power module is configured to supply power to the bidirectional wireless infrared relay control device control device.

A control method of using the above bidirectional wireless infrared relay control device located on an infrared reception end or an infrared transmission end. When the bidirectional wireless infrared relay control device is located on the infrared reception end, the control method includes the steps of: standing by in a standby state to await an infrared control signal; verifying the infrared control signal by the infrared reception module and the microprocessor module, wherein the control method proceeds a next step if the infrared control signal is identical to a set signal value after verification, and wherein the control method returns to the standby state if the infrared control signal is different from the set signal value after verification; editing a radio frequency signal corresponding to a set value of the selection module; and transmitting the radio frequency signal via the antenna.

When the bidirectional wireless infrared relay control device is located on the infrared transmission end, the control method includes the steps of: standing by to await a set radio frequency signal; receiving the set radio frequency signal; generating an infrared control signal; and transmitting the infrared control signal.

In an example, the selection module is a knob switch, a finger-operated switch, a button switch, or integrated in the microprocessor module and set by a program.

In an example, the power module includes a multi-media connector connected to the external electric appliance.

In an example, the multi-media connector is a USB or HDMI connector.

In an example, the infrared reception module includes a first connector connected to a first conductive wire having an infrared receiver, and the infrared transmission module includes a second connector connected to a second conductive wire having an infrared transmitter.

In an example, the first antenna is the second antenna and is shared by the first wireless processing module and the second wireless processing module.

In an example, additional electric appliances and additional bidirectional wireless infrared relay control devices are used. Each of the bidirectional wireless infrared relay control devices is set to correspond to one of the electric appliances to proceed with one-to-one, one-to-many, many-to-one, or many-to-many control.

The control device according to the present invention is suitable for receiving or transmitting infrared control signals and can be installed easily. Furthermore, the control device can be connected by a USB connector to an electric appliance to obtain power. Furthermore, one or more control devices can be used to control one or more electric appliances. Furthermore, the control device can set the object for transmission or reception and can be used for remote control. Thus, the operational convenience and applications of electric appliances can be increased.

The present invention will become clearer in light of the following detailed description of illustrative embodiments of this invention described in connection with the drawings.

### DESCRIPTION OF THE DRAWINGS

FIG. 1 is a diagrammatic block diagram of a control device of an embodiment according to the present invention.

FIG. 2 is a flowchart illustrating steps of operation at an infrared reception end of the control device.

FIG. 3 is a flowchart illustrating steps of operation at an infrared transmission end of the control device.

FIG. 4 is a diagrammatic view illustrating use of a single control device of a first example according to the present invention.

FIG. 5 is a diagrammatic view illustrating one-to-one control of a plurality of control devices of a second example according to the present invention.

FIG. 6 is a diagrammatic view illustrating one-to-many control of a plurality of control devices of a third example according to the present invention.

FIG. 7 is a diagrammatic view illustrating one-to-many control of a plurality of control devices of a fourth example according to the present invention.

FIG. 8 is a diagrammatic view illustrating many-to-one control of a plurality of control devices of a fifth example according to the present invention.

FIG. 9 is a diagrammatic view illustrating many-to-one selective control of a plurality of control devices of a sixth example according to the present invention.

### DETAILED DESCRIPTION OF THE INVENTION

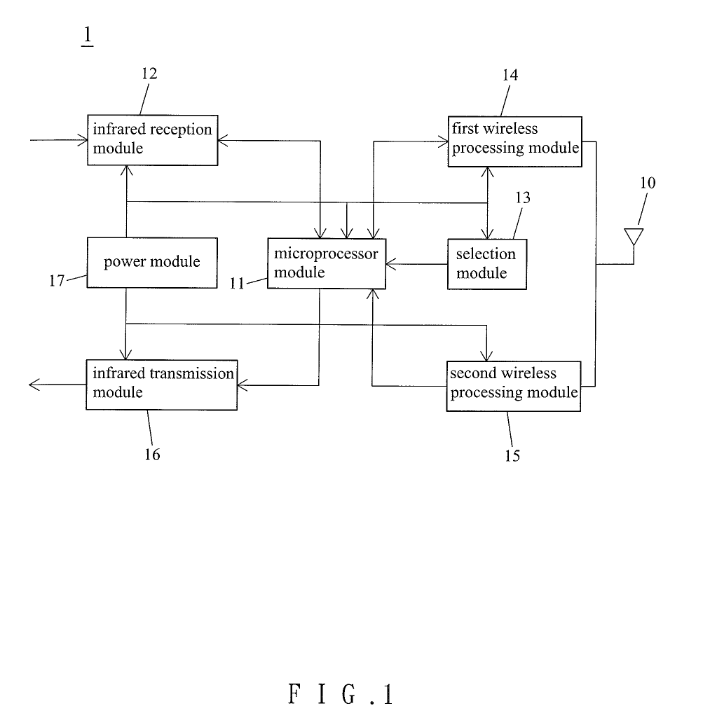

With reference to FIG. 1, a bidirectional wireless infrared relay control device 1 with a pairing function of an embodiment according to the present invention includes a microprocessor module 11, an infrared reception module 12, a selection module 13, a first wireless processing module 14, a second wireless processing module 15, an infrared transmission module 16, and a power module 17. The microprocessor module 11 is electrically connected to the infrared reception module 12, the selection module 13, the first wireless processing module 14, the second wireless processing module 15, and the infrared transmission module 16. The infrared reception module 12 is configured to receive an infrared control signal from a remote controller of an external electric appliance. The infrared control signal is inputted to and decoded by the microprocessor module 11.

The selection module 13 is electrically connected to the microprocessor module 11 and is configured to provide the microprocessor module 11 with a set code signal of transmission or reception. The selection module 13 is a knob switch, a finger-operated switch, a button switch, or integrated in the microprocessor module 11 and set by a program.

The first wireless processing module 14 is electrically connected to the microprocessor module 11 and includes an antenna 10. The microprocessor module 11 cooperates a code from the selection module 13 to generate a radio frequency signal of a corresponding frequency, such as about 433 MHz, 866 MHz, or 915 MHz. The first wireless processing module 14 is configured to send out the radio frequency signal via the antenna 10 through use of frequency-shift keying (FSK) or Gaussian frequency shift keying (GFSK) modulation technique.

The second wireless processing module 15 is electrically connected to the microprocessor module 11 and includes the antenna 10 that is shared by the first wireless processing module 14. The microprocessor module 11 sets the frequency of the radio frequency signal to be received by the second wireless processing module 15. If a radio frequency signal of a corresponding frequency is received, the radio frequency signal can be inputted to the microprocessor module 11. Arrangement of the common antenna 10 reduces the volume and costs.

The infrared transmission module 16 is electrically connected to the microprocessor module 11. When the microprocessor module 11 receives the signal from the second wireless processing module 15, an infrared control signal is generated and sent out.

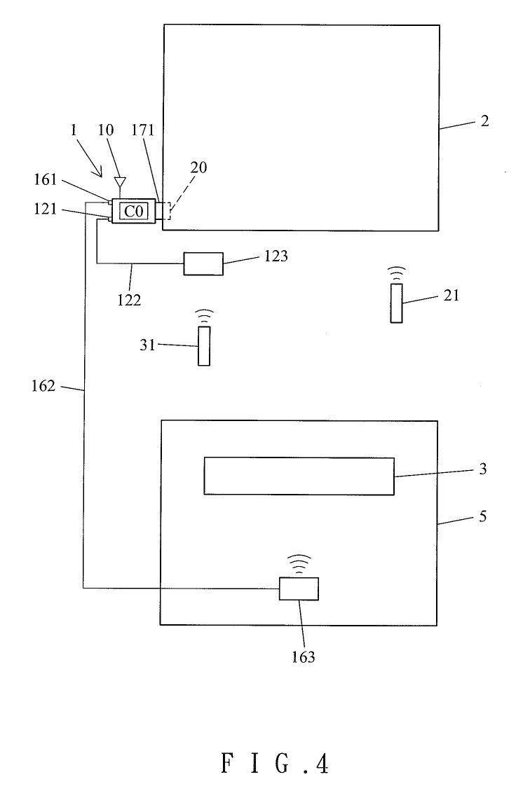

With reference to FIGS. 1 and 4, the power module 17 supplies power to the control device 1. The power module 17 includes a multi-media connector 171 connected to a USB connector 20 of an external first electric appliance 2, such that the power of the external first electric appliance 2 can be supplied to the control device 1.

The infrared reception module 12 includes a first connector 121 connected to a first conductive wire 122 having an infrared receiver 123. The infrared transmission module 16 includes a second connector 161 connected to a second conductive wire 162 having an infrared transmitter 163. Thus, the power module 17 can be coupled to the USB connector 20 of the first electric appliance 2 to obtain power. The infrared receiver 123 and the infrared transmitter 163 are located in positions for easy reception and transmission.

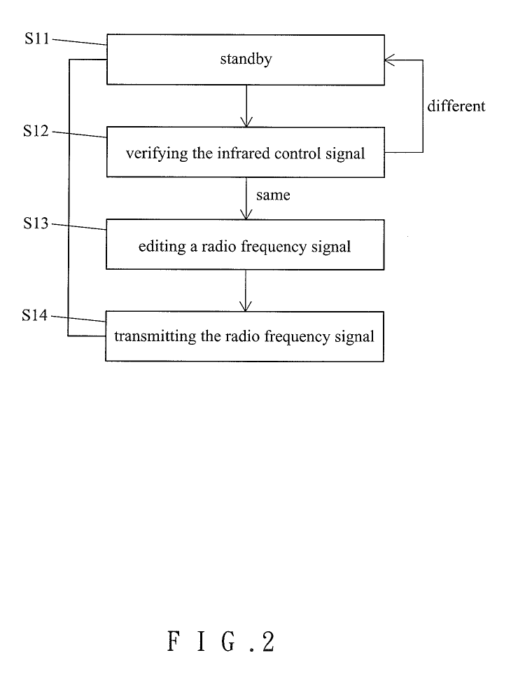

With reference to FIGS. 1 and 2, when the bidirectional wireless infrared relay control device 1 is located on an infrared reception end, the control method includes the steps of: standing by in a standby state to await an infrared control signal (step S11); verifying the infrared control signal by the infrared reception module 12 and the microprocessor module 11 (step S12), wherein the control method proceeds the next step if the infrared control signal is identical to a set signal value after verification, and wherein the control method returns to the standby state (step S11) if the infrared control signal is different from the set signal value after verification; editing a radio frequency signal corresponding to a set value of the selection module 13 (step S13); and transmitting the radio frequency signal via the antenna 10 (step S14). In step S13, the microprocessor module 11 and the first wireless processing module 14 edit the radio frequency signal corresponding to the set value of the selection module 13. The radio frequency signal can be changed according to the set value of the selection module 13.

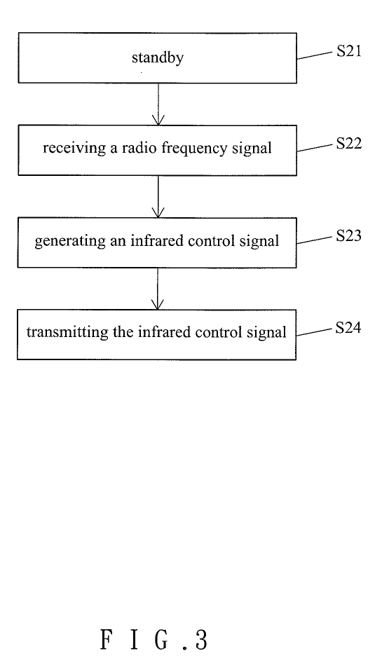

With reference to FIGS. 1 and 3, when the control method the bidirectional wireless infrared relay control device is located on an infrared transmission end, the control method includes the steps of: standing by to await a set radio frequency signal (step S21); receiving the set radio frequency signal (step S22); generating an infrared control signal (step S23); and transmitting the infrared control signal (step S24). In step S21, the radio frequency signal is set by the selection module 13 and has a transmission range about 300 meters to provide better penetration. In step S22, the second wireless processing module 15 receives the radio frequency signal set in step S21. In step S23, the microprocessor module 11 and the infrared transmission module 16 generate the infrared control signal for an electric appliance to be controlled. Thus, the present invention possesses a remote control function.

The selection module 13 can provide multi-band settings of radio frequency signals, such as ten bands corresponding to 915 MHz, 915.3 MHz, 915.6 MHz, 915.9 MHz, 916.2 MHZ, 916.5 MHZ, 916.8 MHz, 917.1 MHZ, 917.4 MHz, and 917.7 MHz and are set as ten codes C0-C9.

The present invention can be applied to ordinary televisions, DVD players, set-top boxes, acoustic equipment, and other electric appliances. Furthermore, the present invention can be set for single use, one-to-many pairing, many-to-one pairing, and many-to-many pairing. With reference to FIGS. 1 and 4, the first example of the present invention uses a single control device 1 in a position within the range of the first and second conductive wires 122 and 162 and includes first and second electric appliances 2 and 3 and corresponding remote controllers 21 and 31. The first electric appliance 2 can be a television 2, and the second electric appliance 3 can be a DVD player. The second electric appliance 3 can be disposed in a cabinet 5 and is, thus, not exposed. The USB connector 171 of the control device 1 is coupled with the USB connector 20 of the first electric appliance 171 to obtain power. Furthermore, the infrared receiver 123 is exposed and can receive infrared control signals from the remote controller 31. Furthermore, the infrared transmitter 163 is disposed in the cabinet 5 and can transmit infrared signals that can be received by the second electric appliance 3.

By such an arrangement, the remote controller 21 can directly control the first electric appliance 2. The user does not have to open the cabinet 5 to make the remote controller 31 transmit an infrared control signal that can be received by the infrared receiver 123 and the infrared reception module 12. Furthermore, the microprocessor 11 makes the infrared transmission module 16 and the infrared transmitter 163 transmit an infrared control signal to operate the second electric appliance 3. Thus, the second electric appliance 3 can be controlled without opening the second cabinet 5, increasing the operational effect of the second electric appliance 2.

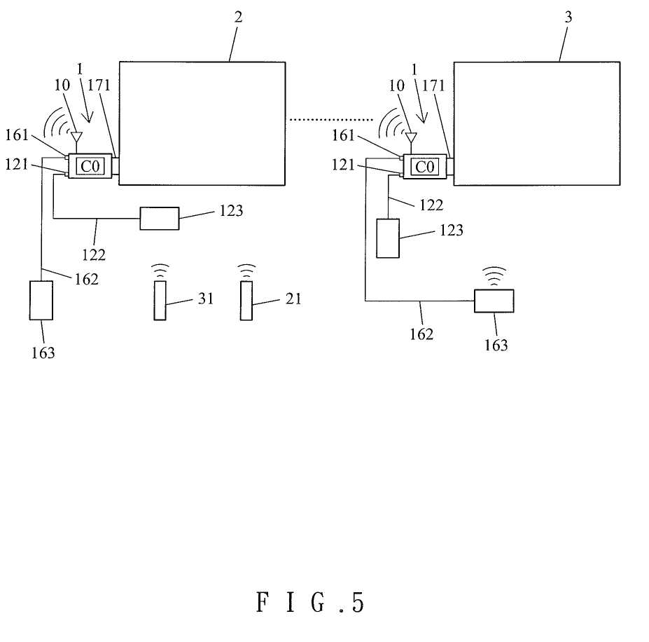

With reference to FIGS. 1 and 5, a second example according to the present invention uses one-to-one control. Two control devices 1 are disposed at the positions of the first and second electric appliances 2 and 3 and include USB connectors 171 respectively connected to the first and second electric appliances 2 and 3 to obtain power. The first electric appliance 2 is spaced from the second electric appliance 3 by a spacing within the radio frequency transmission range (less than about 300 meters). Furthermore, the first and second electric appliances 2 and 3 can be located in different rooms or different floors of a building. Furthermore, the election modules 13 of the control devices 1 select code C0 for mutual pairing and have a radio frequency of 915 MHz. Furthermore, the remote controller 31 of the second electric appliance 3 is associated with the infrared receiver 123 of a corresponding one of the two control devices 1. The infrared transmitter 163 of the other control device 1 corresponds to the infrared reception position (not shown) of the second electric appliance 3. In this example, a user at the position of the first electric appliance 2 uses the remote controller 31 of the second electric appliance 3 to transmit an infrared control signal that is received by the infrared receiver 123. The first wireless processing module 14 of the corresponding control device 1 transmits a radio frequency signal of 915 MHz corresponding to code C0 set by the selection module 13. Furthermore, the radio frequency signal is received by the second wireless processing module 15 of the other control device 1, and the infrared transmission module 16 and the infrared transmitter 163 transmit an infrared control signal to operate the second appliance 3, providing a convenient remote control effect.

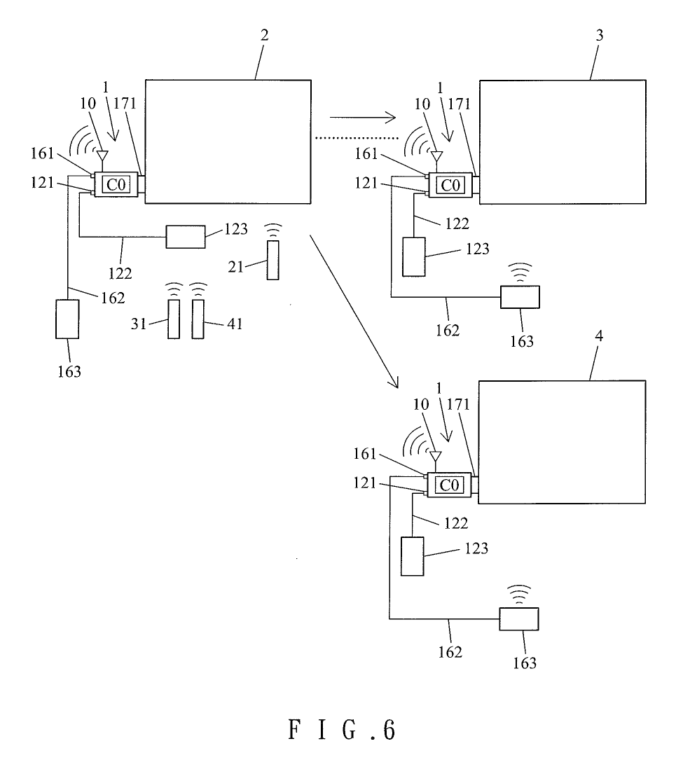

With reference to FIGS. 1 and 6, a third example according to the present invention uses one-to-many control and includes three control devices 1 respectively located in the positions of first, second, and third electric appliances 2, 3, and 4, which is similar to the disposition of the second example. The first, second, and third electric appliances 2, 3, and 4 are spaced from each other by a spacing within the radio frequency transmission range (less than about 300 meters). In this example, the infrared receiver 123 of the control device 1 at the positions of the first electric appliance 2 can receive the infrared control signals transmitted by the remote controllers 31 and 41 of the second and third electric appliances 3 and 4. The infrared transmitters 163 of the other two control devices 1 respectively correspond to the infrared reception positions (not shown) of the second and third electric appliances 3 and 4. The selection modules 13 of the three control devices 3 select code C0 for mutual pairing. Thus, the user at the position of the first electric appliance 2 can control operation of the second and third electric appliances 3 and 4 through remote controllers 31 and 41.

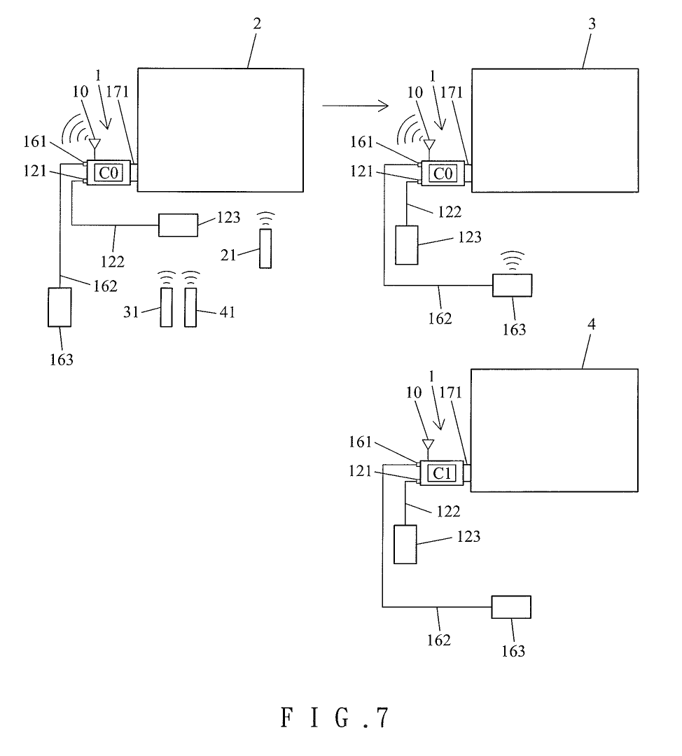

FIGS. 1 and 7 show a fourth example which is similar to the third example except that the fourth example is a selectable arrangement. Specifically, the code of the control device 1 at the third electric appliance 4 is set to be C1 which corresponds to 915.3 MHz. The code of the control device 1 at the position of the first electric appliance 2 is set to be C0 (915 MHz) for pairing with the code C0 of the second electric appliance 3. Thus, the user at the position of the first electric appliance 2 can control operation of the second electric appliance 3 via the remote controller 31. The second wireless processing module 15 of the control device 1 at the position of the third electric appliance 4 cannot receive the radio frequency signal transmitted by the control device 1 at the position of the first electric appliance 2. Thus, the user at the position of the first electric appliance 2 cannot control operation of the third electric appliance 4 via the remote controller 41. As a result, the present invention provides an optional control effect. In an example, the first electric appliance 2 is a television, and the second and third electric appliances 3 and 4 are DVD players. The first electric appliance 2 can only be used to watch films played by the second electric appliance 3 but cannot be used to watch films played by the third electric appliance 4.

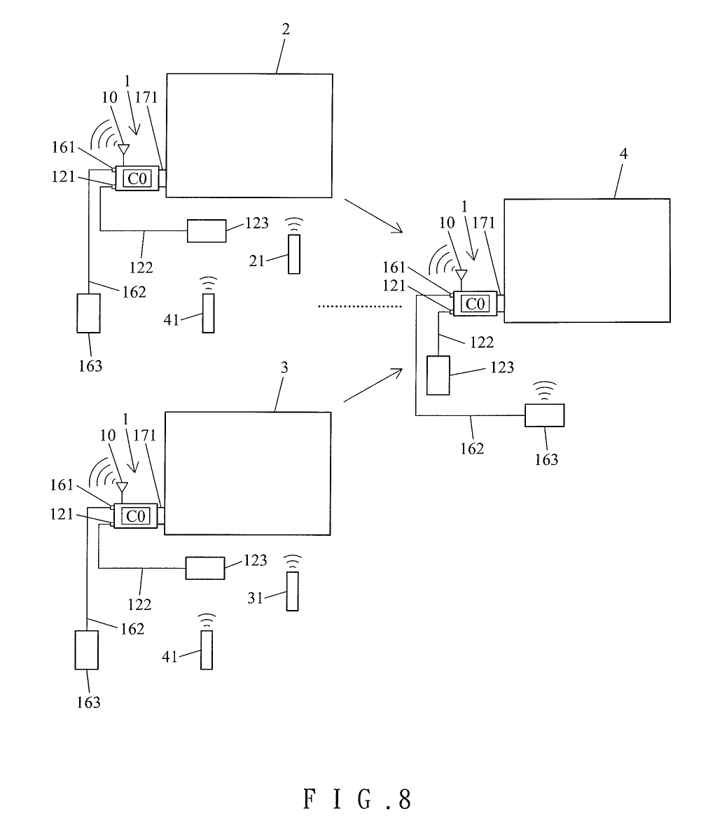

FIGS. 1 and 8 illustrate a fifth example using many-to-one control. Specifically, two control devices 1 are respectively disposed at the positions of the first and second electric appliances 2 and 3. The third electric appliance 4 is disposed within the radio frequency transmission range of the first and second electric appliances 2 and 3. Another control device 1 is disposed at the position of the third electric appliance 4. The code of each control device 1 is set to be C0. Thus, the user at the first electric appliance 2 or the second electric appliance 3 can control operation of the third electric appliance 4 via the remote controller 41 of the third electric appliance 4.

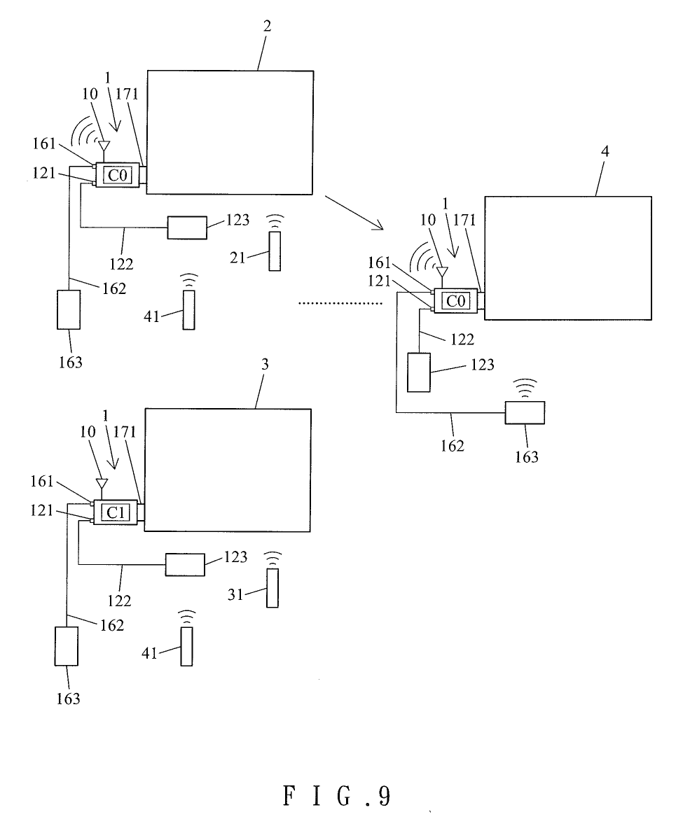

FIGS. 1 and 9 illustrate a sixth example using many-to-one control similar to the fifth example. The main difference is that the code of the control device 1 at the position of the second electric appliance 3 is set to be C1 and is different from the code C0 of the control devices 1 at the first and third electric appliances 2 and 4. Thus, the user at the position of the first electric appliance 2 can use the remote controller 41 to control the third electric appliance 4 but cannot control the third electric appliance 4 from the position of the second electric appliance 3.

The present invention can include more electric appliances and more control devices for many-to-many control. Furthermore, the present invention can be installed easily. The power modules 17 of the control devices 1 can be connected to a main power via conductive wires or HDMI connectors, rather than USB connectors. The types, codes, and frequencies mentioned above are merely non-restrictive examples not intended for limiting the present invention.

Although specific embodiments have been illustrated and described, numerous modifications and variations are still possible without departing from the scope of the invention. The scope of the invention is limited by the accompanying claims.

1. A bidirectional wireless infrared relay control device with a pairing function, comprising:
a microprocessor module;
an infrared reception module electrically connected to the microprocessor module, with the infrared reception module configured to receive an infrared control signal from a remote controller of an external electric appliance and configured to send the infrared control signal to the microprocessor module for decoding;
a selection module electrically connected to the microprocessor module and configured to provide the microprocessor module with a set code signal of transmission or reception;
a first wireless processing module electrically connected to the microprocessor module and including a first antenna, with the microprocessor module cooperating a code from the selection module to generate a radio frequency signal with a corresponding frequency, with the first wireless processing module configured to send out the radio frequency signal via the first antenna;
a second wireless processing module electrically connected to the microprocessor module and including a second antenna, with the second wireless processing module set by the microprocessor module and the selection module to receive the radio frequency signal;
an infrared transmission module electrically connected to the microprocessor module; and
a power module configured to supply power to the bidirectional wireless infrared relay control device control device.

2. The bidirectional wireless infrared relay control device with a pairing function as claimed in claim 1, wherein the selection module is a knob switch, a finger-operated switch, a button switch, or integrated in the microprocessor module and set by a program.

3. The bidirectional wireless infrared relay control device with a pairing function as claimed in claim 1, wherein the power module includes a multi-media connector connected to the external electric appliance.

4. The bidirectional wireless infrared relay control device with a pairing function as claimed in claim 3, wherein the multi-media connector is a USB or HDMI connector.

5. The bidirectional wireless infrared relay control device with a pairing function as claimed in claim 1, wherein the infrared reception module includes a first connector connected to a first conductive wire having an infrared receiver, and wherein the infrared transmission module includes a second connector connected to a second conductive wire having an infrared transmitter.

6. The bidirectional wireless infrared relay control device with a pairing function as claimed in claim 1, wherein the first antenna is the second antenna and is shared by the first wireless processing module and the second wireless processing module.

7. The bidirectional wireless infrared relay control device with a pairing function as claimed in claim 1, further comprising additional electric appliances and additional bidirectional wireless infrared relay control devices, wherein each of the bidirectional wireless infrared relay control devices is set to correspond to one of the electric appliances to proceed with one-to-one, one-to-many, many-to-one, or many-to-many control.

8. A control method of using the bidirectional wireless infrared relay control device set forth in claim 1, with the bidirectional wireless infrared relay control device located on an infrared reception end or an infrared transmission end,
wherein when the bidirectional wireless infrared relay control device is located on the infrared reception end, the control method comprises the steps of:
standing by in a standby state to await an infrared control signal;
verifying the infrared control signal by the infrared reception module and the microprocessor module, wherein the control method proceeds a next step if the infrared control signal is identical to a set signal value after verification, and wherein the control method returns to the standby state if the infrared control signal is different from the set signal value after verification;
editing a radio frequency signal corresponding to a set value of the selection module; and
transmitting the radio frequency signal via the antenna, and
wherein when the bidirectional wireless infrared relay control device is located on the infrared transmission end, the control method comprises the steps of:
standing by to await a set radio frequency signal;
receiving the set radio frequency signal;
generating an infrared control signal; and
transmitting the infrared control signal.

9. The control method as claimed in claim 8, wherein the selection module is a knob switch, a finger-operated switch, a button switch, or integrated in the microprocessor module 11 and set by a program.

10. The control method as claimed in claim 8, wherein the power module includes a multi-media connector connected to the external electric appliance.

11. The control method as claimed in claim 8, wherein the multi-media connector is a USB or HDMI connector.

12. The control method as claimed in claim 8, wherein the infrared reception module includes a first connector connected to a first conductive wire having an infrared receiver, and wherein the infrared transmission module includes a second connector connected to a second conductive wire having an infrared transmitter.

13. The control method as claimed in claim 8, wherein the first antenna is the second antenna and is shared by the first wireless processing module and the second wireless processing module.

14. The control method as claimed in claim 8, further comprising additional electric appliances and additional bidirectional wireless infrared relay control devices, wherein each of the bidirectional wireless infrared relay control devices is set to correspond to one of the electric appliances to proceed with one-to-one, one-to-many, many-to-one, or many-to-many control.
